(19) United States
(12) Patent Application Publication
(10) Pub. No.: US 2016/0225067 A1
(43) Pub. Date: Aug. 4, 2016

(54) Method of Browsing User Interactive In-store Electronic Catalog

(71) Applicant: SmoothWeb Group Ltd., Hong Kong (HK)

(72) Inventor: Rajiv Trehan, Tokyo (JP)

(21) Appl. No.: 14/612,641

(22) Filed: Feb. 3, 2015

(51) Int. Cl. G06Q 30/06

(52) U.S. Cl. CPC G06Q 30/0643

(57) ABSTRACT

The present invention relates to a method of browsing an interactive in-store electronic catalog for mixing and matching product(s) and/or accessory(ies) such as apparel(s) on main control screen and displaying on multiple display screens. The method provides multiple key visuals on a control screen representing signature; where a user selects a signature represented by the key visual on the control screen; and their components are displayed on display screen. Therefore, allowing user to mix and match his/her choices on the control screen and displaying the results on display screen for viewing.

### FIELD OF INVENTION

The present invention relates to a method of browsing an interactive in-store electronic catalog. More specifically, the invention relates to a method of simplifying user interaction for mixing and matching product(s) and/or accessory(ies) such as apparel(s) on multiple display screens.

### BACKGROUND OF THE INVENTION

In recent years, technology has helped the in-store apparel shopping become more pleasant, convenient and less time consuming. In the past, a customer had to browse through the whole store and keep a vigilant eye to locate the desired apparel and make suitable combination(s) or match(s). Such an ordeal usually involved a store assistant who would help in locating our desired apparel and layout the best possible combination(s).

Existing virtual in-store dressing method(s) allows a shopper to browse through the store's catalogue electronically, provide associated information and then create a simulated trial room. Such in-store dressing methods usually provide a single screen display apparatus that allows a shopper to browse through in-store catalogue on a single screen and to virtually try on a selected item and determine suitability based on fit, cut, design, size, color etc.

However, none of these system(s) and method(s) provides an option in a multi-monitor display system that will help a user to mix and match apparel(s) and/or accessory(ies).

The current technologies provide an interactive dressing systems and methods, for example: US 20140061295 A1 provides systems and methods for providing an interactive toy dressing system. The system is designed to coordinate toy outfit purchasing with advice and can further provide a playful environment in which it assists users by determining and coordinating clothing options that are available; and locating them for purchase. The interactive dressing system provides the screen display comprising of plurality of displays which may be selected via the touch screen; in US 20140063056 A1 provides systems, apparatuses, methods and computer program for virtually and interactively fitting at least one wearable item on a user. The method comprises the steps of (a) collecting, via an image collecting device, one or more images of the user; (b) tracking, via a motion sensing device, one or more movements of the user; (c) converting, via a data processing unit, the one or more images to generate a representation representing one or more physical attributes of the user; (d) fitting, via the data processing unit, a plurality of article coordinates representing the at least one wearable item to the representation representing one or more physical attributes of the user to generate one or more fitted images of the user wearing the at least one wearable item; and (e) displaying, on a display component, one or more fitted images of the user wearing at least one wearable item; and in US 20140201023 A1 provides a multimedia device, a method, apparatus, and system for presenting product information to a user, it provides the means and methods for user to virtually try on the products with user specific image/photo through user interaction, graphical image processing and generation, loading and switching images to generate a continuous virtual fitting experience. Collect and manage user input data and facilitate interaction between consumer and vendor.

Although, US 20140061295 A1 describes a multi-monitor screen but it does not provide a specific method of display, that augment interactive in-store electronic catalog browsing by providing a primary control screen and plurality of display screens to display the details or alternatives of the choices made on the primary control screen.

Other prior arts use a single screen display with complex and random navigational tools. The use of such single screen display crams the screen with information. Therefore, a user is more involved in getting used to the system, scroll and browse the in-store electronic catalog rather than exploring the right options and combinations.

Another drawback of these present method(s) and system(s) is/are that they facilitate virtual dressing but none of them provide a method to mix and match product(s) and/or accessory(ies) such as apparel(s) on a given key visual. So herein, the present invention provides a method of browsing an interactive in-store electronic catalog that presents a brand's signature line-ups in an intuitive manner, the system comprising of one main control screen and at least one associated display screen (display screen), wherein the selections are made on the main control screen, and the detail(s) and/or information(s) are displayed on one or more display screen(s).

### SUMMARY OF THE INVENTION

The present invention provides an interactive in-store electronic catalog for mixing and matching product(s) and/or accessory(ies) such as apparel(s) by a method of browsing, the method comprising of: providing multiple key visuals on a control screen representing signatures; enabling a user to select a key visual on the control screen; allowing a user to mix and match component(s) of the signature on the selected key visual on the control screen; and displaying mixed and matched component(s) on one or more display screens.

In the interactive in-store electronic catalog, the user gesture such as swipe the control screen rotating through each key visual representing signature the components of the signature are displayed on the display screens. When the user finds a key visual representing signatures of his/her liking, the user can start mixing and matching component from the control screen, and displayed on display screen accordingly. Subsequently, each time a new Key visual representing signature is displayed on the control screen and the components of the signature are displayed on the display screens.

In general, non-interactive mode the control screen rotates slowly through each key visual representing signature, where a new key visual representing signature appears on the control screen and the components of the signature are displayed on the display screens.

The key visuals enlisted on the control screen include any model or any celebrity or a person or any figurine endorsing or promoting particular product(s) and/or accessory(ies). The control screen is a touch screen for advertising or displaying multiple key visuals and thereby allowing a user to interact by selecting a key visual for viewing, mixing and matching product(s) and/or accessory(ies) such as apparel(s) independently in-store.

The signature is associated with a key visual which is classified into style or type for brand lineup or seasonal apparel(s) and/or accessory(ies). The component(s) of the signature represented by key visual provides varieties of product(s) and/or accessory(ies) such as apparel(s) such as but not limited to hat, scarf shirt, jacket, shirt, pants, shoes, ear rings, cufflinks, lockets, chains etc. The display screen may comprise of one or more display screen(s) connected to a control screen so that component(s) of the signature of selected key visual is substantially displayed on one or more display screen for viewing, mixing and matching. The method further provides a user to alter background images on the control screen to depict different scenarios such as gym, city, night time, and beach etc. to mix and match product and/or accessory(ies) such as apparel(s) in different environment. The method further provides mixing and matching product(s) and/or accessory(ies) such as apparel(s) between one or more brands.

### BRIEF DESCRIPTION OF THE DRAWINGS

The following invention will be described with reference to the following drawings. The drawings and the associated descriptions are provided to illustrate embodiments of the invention and not to limit the scope of the invention.

FIG. 1 illustrates a method of displaying key visual representing signatures in a user non-interactive mode.

FIG. 2 illustrates a method of browsing an in-store electronic catalog for mixing and matching product(s) and/or accessory(ies) such as apparel(s) in a user interactive mode.

FIG. 3 shows an exemplary method of displaying key visual representing signatures.

FIG. 4 illustrates a schematic arrangement of the system for providing user interactive in-store electronic catalog.

### DETAIL DESCRIPTION OF THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated or distorted and not drawn on scale for illustrative purposes. Where an indefinite or definite article is used when referring to a singular noun e.g. “a” or “an”, “the”, this includes a plural of that noun unless something else is specifically stated.

The present invention now will be described more fully hereinafter with reference to the accompanying drawings, in which some, but not all embodiments of the inventions are shown. While the following description details the preferred embodiments of the present invention is not limited in its application to the details of construction and arrangement of the parts illustrated in the accompanying drawings.

With reference to the figures, numerical designation has been given for each element to facilitate the reader's understanding of the present invention, and particularly with reference to the embodiments of the present invention illustrated in the figures; various preferred embodiments of the present invention are set forth below. The enclosed description and drawings are merely illustrative of preferred embodiments and represent several different ways of configuring the present invention. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

### DEFINITION(S)

The term “Key Visual” refers to any recommended configuration or typical combination or model or any celebrity or a person or any figurine endorsing or promoting particular product(s) and/or accessory(ies).

The term “Signature(s)” refers to a style associated with a brand lineup and may take inspiration from different seasons, place, occasion and profession. Therefore, for seasons different “Signature” may refer to winter, summer, spring etc. For place(s) different “Signature” may refer to office, university, beach, formal party etc. For profession(s) different “Signature” may refer to golfer, professor, business etc.

The term “component(s)” refers to a constituent(s) of a signature represented by a Key Visual. The component may be an article of clothing or options available for product(s) and/or accessory(ies) within the signature, such as in apparel(s) examples include hat, scarf, shirt, jacket, shirt, pants, shoes, ear rings, cufflinks, lockets, chains etc.

The present invention provides a method of browsing an interactive in-store electronic catalog that presents a brand's signature line-ups in an intuitive manner, the system comprising of one main control screen and at least one associated display screen (satellite screen), wherein the selections are made on the main control screen, and the detail(s) and/or information(s) are displayed on one or more display screen(s).

For example the main control screen provides a key visual such as a celebrity in a signature such as beach wear, gym wear, golf wear etc. Further, each signature comprises of components which are basically elements that are worn by a key visual. A user selects a key visual representing signature on the control screen and components of key visual.

The method reduces the fuss of navigation as one control screen and at least one satellite screen referred as display screen is associated with the control screen to display information.

Moreover, the method helps individuals who are at a loss where to begin. The key visual such as a celebrity acts as a starting point for a specific signature. The components of the key visual representing signatures such as shoes, tops, trousers etc can be mixed and matched from the inventory that has been electronically listed. The mixing and matching is performed on the main control screen and is visualized on the display screens.

In one embodiment of the present invention provides, a n interactive in-store electronic catalog for mixing and matching product(s) and/or accessory(ies) such as apparel(s) by a method of browsing, the method comprising of: providing multiple key visuals on a control screen representing signatures; enabling a user to select a key visual on the control screen; allowing a user to mix and match component(s) of the signature on the selected key visual on the control screen; and displaying mixed and matched component(s) on display screen.

The key visuals enlisted on the control screen include a person or figurine endorsing or promoting particular apparel(s) and/or accessory(ies).

In the user interactive in-store electronic catalog, the user gesture such as swipe the control screen rotating through each key visual representing signature the components of the signature are displayed on the display screens. When the user finds a key visual representing signatures of his/her liking, the user can start mixing and matching components on the control screen, and these components are displayed on display screen accordingly. Subsequently, each time a new Key visual representing signature is displayed on the control screen and the default components of the signature are displayed on the display screens.

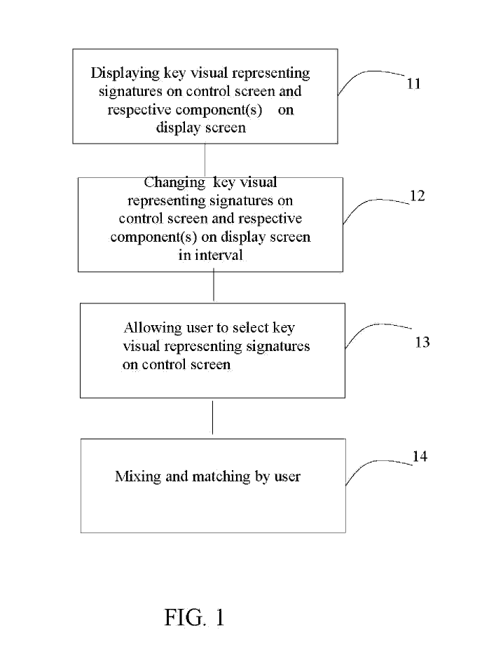

As shown in FIG. 1, in non-interactive mode, displaying each key visual representing signature on the control screen and the respective component(s) on the display screens 11, where the control screen display rotates slowly changing the key visual and respective component(s) on the display screens 12. Therefore, allowing a user to select key visual representing signature on control screen 13. Further, mixing and matching of the component(s) is carried out by user to his/her liking 14.

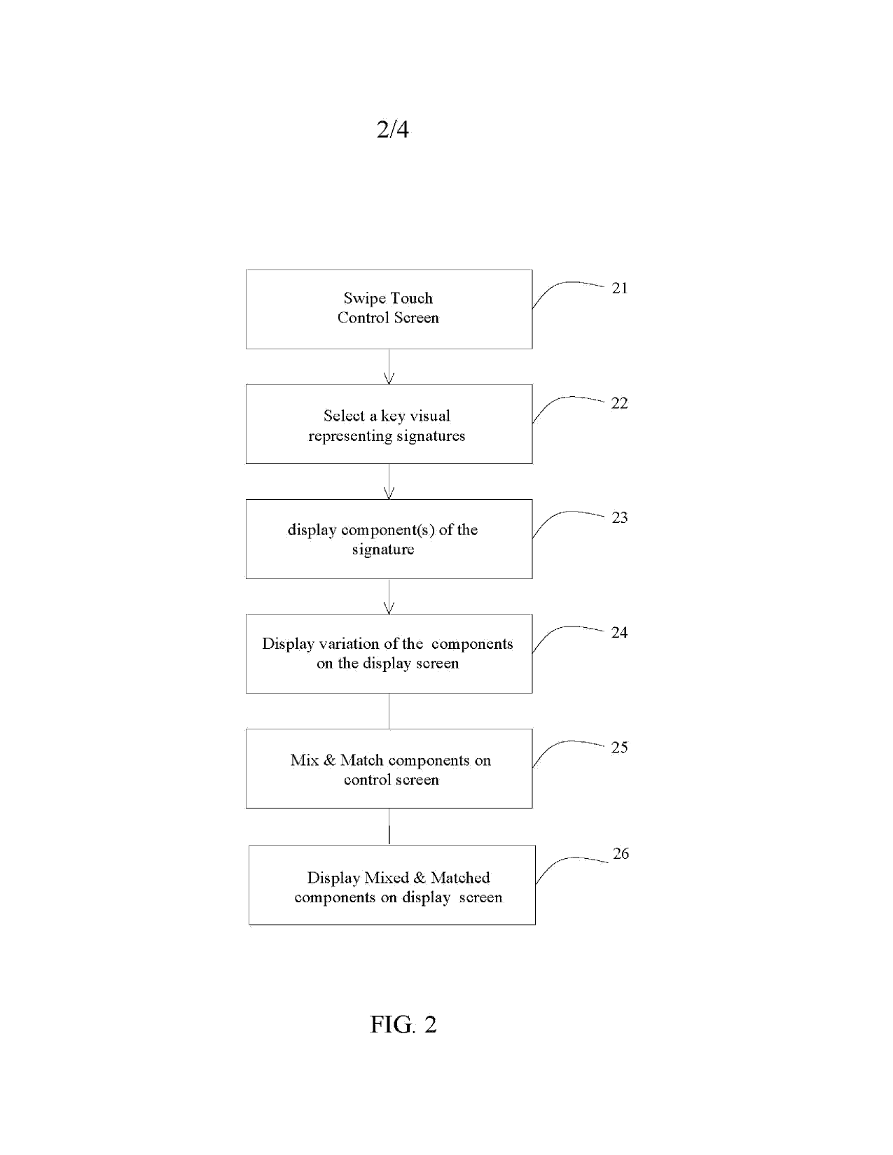

FIG. 2 illustrates the method of browsing an in-store electronic catalog for mixing and matching apparel(s) and/or accessory(ies). A user gesture such as swipe a touch control screen 21 to select key visual representing signatures 22. After a key visual representing signature is selected, the components are displayed on the display screens 23. User selects a component variation on the control screen, thereby the variation of component is displayed on the display screens 24 and at the end, the user can mix and match component(s) of his/her liking on the control screen 25; and accordingly mixed and matched component are displayed on display screen 26. Therefore, allowing the user or customer to mix and match the apparel and/or accessories in accordance to sizes, colors etc.

The component(s) of the signature provides variety of product(s) and/or accessory(ies) such as apparel(s) such as but not limited to hat, scarf, shirt, jacket, shirt, pants, shoes, ear rings, cufflinks, lockets, chains etc.

The component(s) of the signature provides a variety of product(s) and/or accessory(ies) such as apparel(s) further including default value(s) such as size, colour, cut etc.

The method further provides a user to alter background images on the control screen to depict different scenarios such as gym, city, night time and beach etc. to mix and match product(s) and/or accessory(ies) such as apparel(s) in different environment.

The method further provides mixing and matching apparel or accessories between one or more signatures in which signature filters are used for filtering signatures when mixing and matching component(s) between one or more signatures. The signature filters are user defined data for limiting the component(s) for mixing and matching across different signatures.

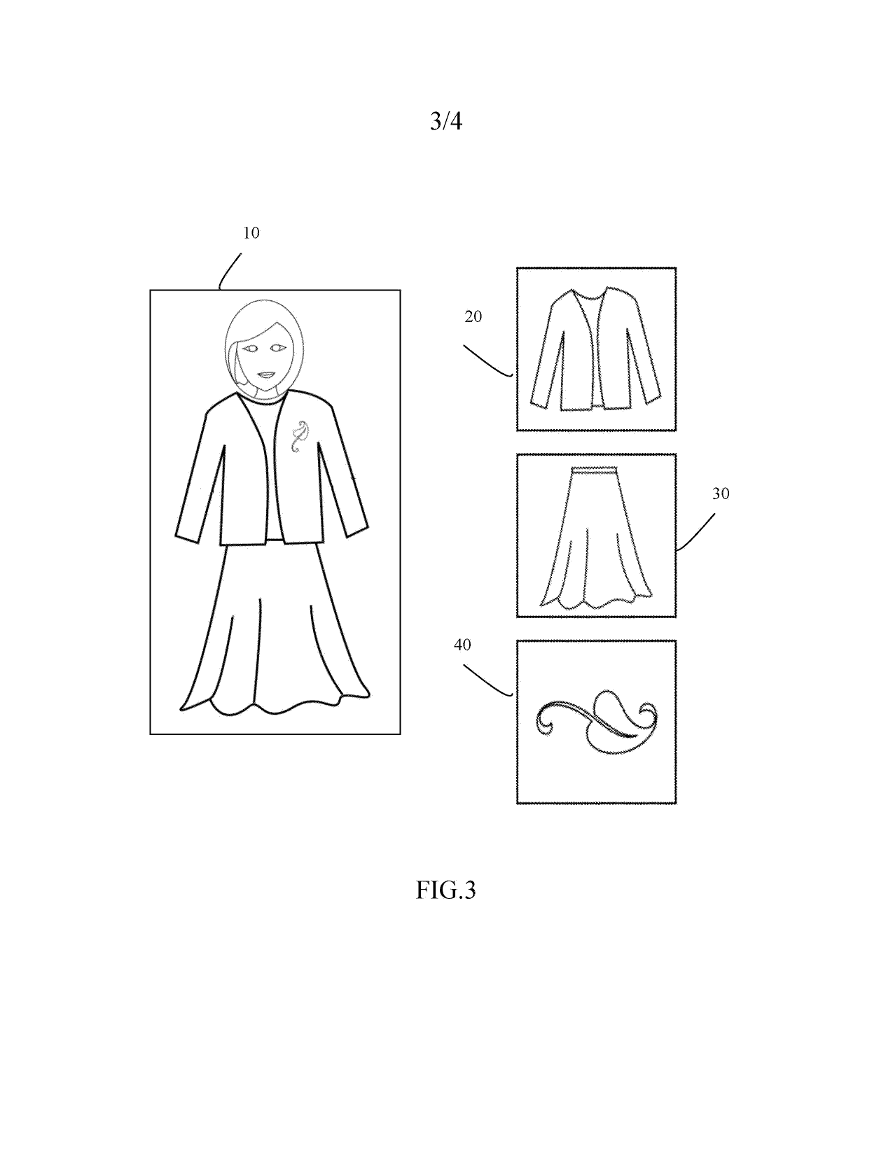

FIG. 3 presents an exemplary method of displaying a key visual representing signature in which a key visual representing signature is on the control screen 10 and their components on display screens 20, 30 & 40. A user interacts on control screen 10 to select key visual representing signatures of his/her liking, mixing and matching the components and variation of the components is displayed on display screen 20, 30 & 40. The display screen 20 provides image and details of one component such as Jacket. In this representation, the components of key visual representing signatures is displayed individually for the user to experience the look of the components so that the user can mix and match components of its choice.

The method for browsing an interactive in-store electronic catalog on a multi-screen electronic display screen for a user to mix and match apparel(s) and/or accessory(ies), preferably are of three types (i) Structured Browsing Approach (ii) Signature Component Variation Approach (iii) Signature Component Replacement Variation Approach.

In Structured Browsing Approach, Key Visual (such as a Celebrity) is visible on a control screen advertising a Signature. The control screen rotates through, all the Key Visuals and the user may select a specific Signature. For example, a user or customer selects some celebrity wearing a Winter Relax Signature. Each signature is made up of components such as hat, scarf, shirt, jacket, shirt, pants and shoes and is displayed on the display screens.

If there are three display screens and the user selects the Key Visual Signature: Winter Relax Signature on the control screen, in which, display screen #1 shows the hat and scarf signature components in as the Key Visual Signature; screen #2 shows the jacket and shirt signature components in as the Key Visual Signature; and display screen #3 shows the Pants and shoes signature components in as the Key Visual Signature.

In Signature Component Variation Approach, the signature component variation on the control screen, the customer may see the signature and component variations for each of the components that make up a Key Visual; for example, if a customer wishes to see the variations in scarf for the Winter Relax Signature range, then on the control screen the user or customer needs to select the scarf icon and the variations (e.g. different colours, materials, pattern etc) of the scarf shall appear on the control screen(s). Further, if the user or customer then selects a scarf component variation then the variation appears on the satellite screen.

In Signature Component Replacement Variation Approach the control screen displays the component variations for each of the components that make up signature of a Key Visual. Additionally, for each component they can see a non-signature but related component variations e.g. Winter Relax Signature Scarf Component can show Japan Ski Signature Scarf Component. For example, the customer may wish to see the scarf component variations in the Winter Relax Signature, therefore on the control screen the customer opts for Signature Component Scarf icon and the variations (e.g. different colours, materials, pattern etc) of the scarf appear. However, if the customer wishes to view other non-signature scarf that are related then the customer can select this option and then other variations shall appear (e.g. Japan Ski Signature Scarf Component variations) on the control screen. If the customer then selects a non-signature component variation then that variation appears on the display screen. In this scenario, the display screens display signature components for the hat, shirt, jacket, shirt, pants, shoes etc. and a non-signature component for the scarf. Wherein, a signature filter may be employed for identifying related signatures when mixing and matching component(s) between one or more signatures.

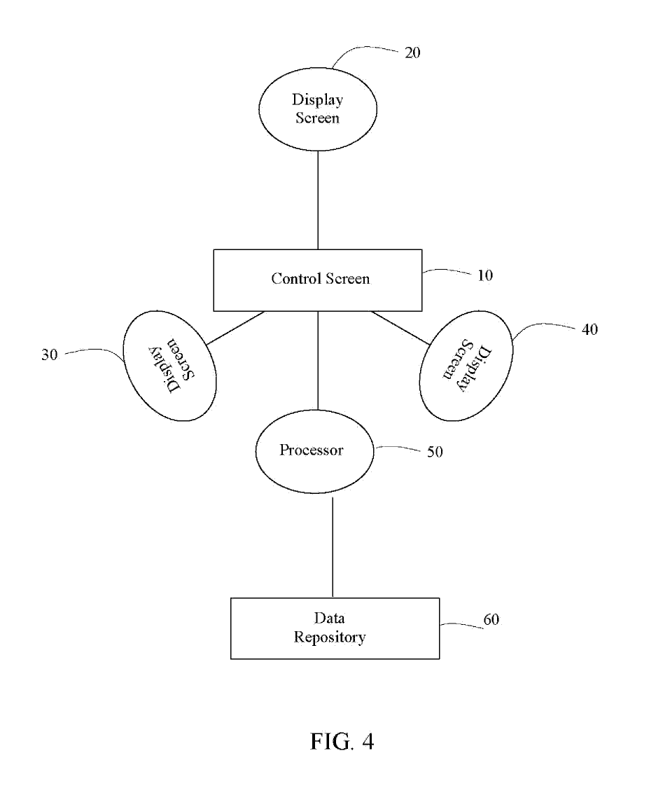

FIG. 4 illustrates a schematic arrangement of the system. The system primarily comprises of a control screen 10 and associated display screens 20, 30 & 40. The control screen 10 is connected to a processor or computer 50 and product catalog data repository 60 from which the information about the key visual is retrieved.

The control screen is an interactive screen, such as but not limited to touch, BLE activated, camera censor, kinetics for advertising or displaying multiple key visuals and thereby allowing a user to interact by selecting a key visual for viewing, mixing and matching product(s) and/or accessory(ies) such as apparel(s) independently in-store.

The display screen may be one or more satellite screen(s) connected to a control screen so that component(s) of the signature of selected key visual is substantially displayed on one or more display screen for viewing, mixing and matching.

The display screens are connected to a control screen which can be placed at different location(s) in any arrangement such as behind a mirror or on a large LED wall. Similarly, instead of using a LED, a projection image may be used.

The control screen may be selected from any electronic communication device(s) such as tablet, phone, computers or laptops or other similar devices stored with details of the apparel(s) and/or accessory(ies).

The use of multiple display screens allows the user to have better interaction and shopping experience. The display screens provides the visual representation for considering various fashion combinations, while the control screen provides a simple interface for option selection.

The control screen primarily displays a company's electronic catalog by associating signatures with Key Visuals and displaying these Key Visuals on the main control screen; the control screen rotates through each Key Visual, as it rotates the control screen displays the signature components with default properties on the display screens; a customer can also select a specific Key Visual on the main screen and the signature components with default properties automatically are displayed on the display screens; further allowing a customer to mix and match components on the main screen so that they appear on the display screens.

The selection of a Key Visual in a particular signature style on the control screen drives the display screens to show all the components of associated signature for the Key Visual.

The user can view the key visual on a control touch screen; view the product(s) and/or accessory(ies) such as apparel(s) and information associated with the key visual on one or more display screens.

The main screen also allows a user to experiment with the signature on the display screens by allowing the user to change properties of the signature or components and to replace signature or components with different signatures or components. The user can mix and match the components of associated signature and of related signatures by selecting these on the control screen and displayed on display screens, thereby providing a very structured approach to mix and matching of components within or across signatures. Wherein, a signature filter may be employed for identifying related signatures when mixing and matching component(s) between one or more signatures.

The configuration is controlled via data files and allows the system to be used offline. However, these files can be generated on the fly for online usage and interfaced to inventory and stock control systems. The model and data is statement of key visual>signatures and key visual>signature part>images. The images are ordered so as to identify the key image for each key visual and identify a replacement in the case of no inventory.

The user can change the context of the key visual by changing the background image on the control touch screen and therefore on all the display screens e.g. change the background image from a running track to a beach setting on the control touch screen and the backgrounds on the display screens automatically change. Therefore the present invention also provides added advantage of manipulating the background image to check wear-ability or suitability in different environments. A background change in the control screen changes the background in all the display screens.

Further, the system helps the customer for option/ability to calculate and display the overall price for the configuration being viewed. Also, if the customer wishes to view other configuration, the overall prices of variation may appear accordingly. In addition, the system can allow automated or manual change to the pricing model in each store or group of stores, for example price adjustments could be based on but not limited to time sales, available stock or customer loyalty.

The database that houses the electronic catalog is a relational database in an online environment e.g. SQL Server, MySQL, Postgres etc, however in case of offline environment the product catalogue is housed in a local storage device such as a hard drive, flash drive etc.

The control screen can also be can also be controlled by keyboard, mouse, Microsoft Connect®, BLE etc. The control screen could be a tablet, phone or other touch enabled device that allow variations and alternative apparel options to be selected. These screens are connected using software; the control touch screen determines what appears on the display screens. There may be one or more display screens. The product line-ups and their relationships are accessed from a product catalog database.

One skilled in the art will appreciate that the embodiments provided above are exemplary and in no way limit the present invention.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to apparel shopping, it can also accommodate other products such as PC hardware, Cars, Furniture, Holiday packages etc. This is only one of several implementations; such features may be combined with one or more other features of other implementations as may be desired and advantageous for any given or particular application.

Similarly, an implementation of the invention in the PC industry can be for mixing and matching hardware/software, performed on the control screen. The control screen primarily displays a company's electronic catalog with different models of PC in the same or different brand(s) and associated compatible hardware(s)/software(s) of the same brand(s) or different brand(s) on the display screens. The control screen rotates through different models of PC's in the same or different brand and as it rotates on the control screen, the compatible hardware(s)/software(s) accessories are displayed on the display screens. A customer may mix and match components on the main screen so that they appear on the display screens.

Similarly an implementation in the automobile industry may include mixing and matching components on the control screen, primarily displaying a company's electronic catalog with different models of automobile on the control screen and associated optional features from on the display screens. The optional features may include but are not limited to seating type, colour of the car, additional mechanical and/or electronic features etc. The control screen rotates through different models of automobile(s) and as it rotates on the control screen, optional features are displayed on the display screens. A customer may mix and match components on the main screen so that they appear on the display screens.

Similarly an implementation in the service industry such as providing Holiday packages may include mixing and matching components on the control screen, primarily displaying a base pack on the control screen and associated optional features on the display screens. The optional features may include but are not limited to type of room, type of hotel, complementary food etc. The control screen rotates through different base holiday pack and as it rotates on the control screen, optional features are displayed on the display screens. A customer may mix and match components on the main screen so that they appear on the display screens

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The Abstract of the disclosure will allow the reader to quickly ascertain the nature of the technical disclosure. It is submitted with the understanding that it will not be used to interpret or limit the scope or meaning of the following claims.

What is claimed is:

1. An interactive in-store electronic catalog for mixing and matching product(s) product(s) and/or accessory(ies) such as apparel(s) by a method of browsing, the method comprising of:
providing multiple key visuals on a control screen representing signatures;
enabling a user to select a key visual on the control screen;
allowing a user to mix and match component(s) of the signature on the selected key visual on the control screen; and
displaying mixed and matched component(s) on display screen.

2. The method of claim 1, wherein the key visual is enlisted on the control screen which includes any recommended configuration or typical combination or a person or figurine endorsing or promoting particular product(s) and/or accessory(ies) such as apparel(s).

3. The method of claim 1, wherein the control screen is an interactive screen, such as but not limited to touch, BLE activated, camera censor, kinetics for advertising or displaying multiple key visual and thereby allowing a user to interact by selecting a key visual for viewing mixing and matching product(s) and/or accessory(ies) such as apparel independently in-store.

4. The method of claim 1, wherein the signature is associated with a key visual which is classified into style or type or brand lineup.

5. The method of claim 1, wherein the component(s) of the signature represented by key visual provides varieties of product(s) and/or accessory(ies) such as in apparel(s) examples includes but not limited to hat, scarf, shirt, jacket, shirt, pants, shoes, ear rings, cufflinks, lockets, chains etc.

6. The method of claim 5, wherein the component(s) of the key visual representing signature provides a variety of different product(s) and/or accessory(ies) such as apparel(s) and their variation in type, size or colour, cut etc.

7. The method of claim 1, wherein the key visual on the control screen may be for other product(s) and/or accessory(ies) such as but not limited to hardware(s), electronic equipment(s), automobile etc.

8. The method of claim 1, wherein the display screen may be one or more satellite screen(s) connected to a control screen so that component(s) of the key visual representing signature is substantially displayed on one or more satellite screen for viewing.

9. The method of claim 1, wherein the display screens are connected to a control screen which can kept nearby to control screen or can be placed at different location(s) in any arrangement such as behind a mirror or using a projection or on a large LED wall.

10. The method of claim 1, wherein the control screen may be selected from any electronic communication device(s) such as tablet, phone, computers or laptops or other similar devices stored with access to the data repository of key visual representing signatures and other related data.

11. The method of claim 1, wherein the method further provides a user to alter background images on the control screen which changes background of the display screens, moreover to depicts different scenarios such as gym, city, night time, beach etc. to mix and match product(s) product(s) and/or accessory(ies) such as apparel(s) in different environment.

12. The method of claim 1, wherein the method helps the customer for option/ability to calculate and display the overall price for the configuration being viewed and also, if the customer wishes to view other configuration, the overall prices of variation may appear.

13. The method of claim 1, wherein the method further provides automated or manual change to the pricing model in each store or group of stores, for example price adjustments could be based on but not limited to time sales, available stock or customer loyalty.

14. The method of claim 1, wherein the method further provides mixing and matching product(s) and/or accessory(ies) such as apparel(s) between one or more brands.

15. The method of claim 1, wherein the method further provides a signature filter to identify related signatures when mixing and matching component(s) between one or more signatures.
